(19) United States
(12) Patent Application Publication
(10) Pub. No.: US 2026/0146051 A1
(43) Pub. Date: May 28, 2026

(54) PROCESS FOR PRODUCING A SOLUTION OF ALKYLLITHIUM

(71) Applicant: Public Joint Stock Company SIBUR HOLDING, Tyumenskaya oblast (RU)

(72) Inventors: Maksim Vladimirovich LIPSKIH, Tomsk (RU); Ivan Anatolevich BABIN, Kislovka (RU); Petr Ivanovich KULCHAKOVSKII, Kazan (RU)

(21) Appl. No.: 19/121,710

(22) PCT Filed: Nov. 10, 2023
(86) PCT No.: PCT/RU2023/050261

§ 371 Date: Apr. 16, 2025

(30) Foreign Application Priority Data
Nov. 16, 2022 (RU) 2022129684

(51) Int. Cl. C07F 1/02

(52) U.S. Cl. CPC C07F 1/02

(57) ABSTRACT

This disclosure relates to a process for producing alkyllithium compounds for use as anionic polymerization initiators, as well as in various organic reactions. More particularly, it relates to a process for producing an alkyllithium solution by reacting lithium metal having a specific surface area of from 1 to 100 cm²/g with an alkyl halide in an organic solvent medium under conditions of high turbulence, wherein the molar ratio of lithium metal to alkyl halide is from 2.5:1 to 5.5:1. The technical result achieved by the present disclosure includes in achieving a high yield of alkyllithium using lithium metal having a low specific surface area under conditions of high turbulence and at a molar ratio of lithium metal to alkyl halide of from 2.5:1 to 5.5:1, which is comparable to the alkyllithium yield achieved using finely dispersed lithium metal particles having a high specific surface area.

### FIELD OF THE INVENTION

The present invention relates to a process for producing solutions of alkyllithium compounds for use as initiators of anionic polymerization and in various organic reactions.

### BACKGROUND OF THE INVENTION

Alkyllithium compounds are widely used as initiators for polymerization of dienes and copolymerization of dienes, for example, with vinyl aromatic compounds.

Currently, in industry, alkyllithium is usually produced by melting lithium metal, dispersing the resulting lithium melt in oil or paraffin in an inert atmosphere with high-speed stirring, followed by washing the resulting dispersed lithium metal particles from the oil with a solvent, which is also used as a solvent in the subsequent step of alkyllithium synthesis. Alkyl halide is then added to the resulting dispersion of lithium metal in a solvent to produce alkyllithium. Such a process is disclosed, for example, in patent RU 2691649 (Glukhovskoy V. S., Blinov E. V., Papkov V. N., Zemsky D. N., Stepanov I. M., published Jun. 17, 2019), wherein lithium metal is pre-dispersed in petrolatum oil, followed by washing the dispersed lithium from the oil using nefras (petroleum solvent).

The main disadvantage of this process is the need for prior preparation of a lithium metal dispersion. This is a time-consuming and expensive procedure that requires high energy consumption to carry out the melting of lithium metal, stirring the resulting highly viscous melt using powerful stirring devices, high consumption of organic solvent to wash the resulting dispersion from oil, as well as costs for the separation of the resulting oil emulsion and solvent. In addition, the resulting alkyllithium may contain impurities due to incomplete washing of dispersed lithium particles from oil residues, as well as due to the occurrence of side reactions of lithium with impurities of aromatic and unsaturated compounds that may be contained in the oil.

It is also known from the prior art that in order to increase the efficiency of alkyllithium synthesis, it is preferable to use lithium metal in the form of particles having a particle size of less than 300 microns (U.S. Pat. No. 5,332,533, FMC Corporation, published Jul. 26, 1994). This is explained by the fact that the reaction of alkyl halide with lithium occurs mainly on the surface of the metal, therefore the smaller the metal particles, the greater the specific surface area and the faster the reaction will proceed.

Thus, patent RU 2095362 (Shcherban G. T, published Nov. 10, 1997) discloses a process for producing n-butyllithium, carried out in a hydrocarbon solvent and in the presence of an inert gas, wherein in the first step n-butyl chloride is reacted with a lithium metal dispersion having a particle size of from 5 to 300 microns in a reactor at a temperature of from 0 to 60° C., followed by the second step of holding the reaction mass at a temperature of from 65 to 90° C., characterized in that in the first step, the synthesis of n-butyllithium is carried out at a molar ratio of n-butyl chloride to lithium equal to 0.65-0.85 of the stoichiometrically required, the resulting reaction products are subjected to separation, unreacted lithium is fed back into synthesis at the same ratio of components, the resulting n-butyllithium solution isolated during the separation is sent to the second step of synthesis, which is completed after adding the second part of the n-butyllithium solution and the remaining amount of n-butyl chloride. In addition, in the first step, the synthesis is carried out with continuous circulation of the reaction mass through a condenser and n-butyl chloride is dosed with respect to lithium at a mass rate of 0.25-2.5 hr⁻¹ and introduced preferably at the point with the lowest temperature.

The main disadvantage of the process disclosed therein is the complexity of its practical implementation, as well as the possibility of formation of stable suspensions of lithium chloride by-product in n-butyllithium solution under the described conditions of prolonged vigorous mechanical stirring, as a result, the obtained n-butyllithium contains a large amount of lithium chloride not separated during filtration.

U.S. Pat. No. 7,005,083 (SQM Lithium Specialties Limited Partnership, published Feb. 28, 2006) discloses a process for producing alkyllithium compounds in a liquid hydrocarbon solvent selected from the group of liquid saturated aliphatic hydrocarbons containing 5 to 12 carbon atoms, saturated liquid cycloaliphatic hydrocarbons containing 6 to 12 carbon atoms or mixtures thereof, by reacting alkyl halides containing 3 to 16 carbon atoms with metal particles of less than 300 microns in size (lithium-sodium alloy with a sodium content of 15-34% by weight is used as a metal). Said process allows to obtain alkyllithium compounds of high purity and in a yield of at least 90%. The disadvantages of said process for producing alkyllithium compounds are that handling of lithium-sodium alloy causes a high risk of fire and explosion and a slurry of lithium and sodium chlorides is formed, which is difficult to separate from the target product.

There is a known method of producing alkyllithium by reacting a lithium dispersion with an alkyl halide in hydrocarbon solvents using lithium metal in the form of a dispersion having a particle size of up to 300 microns, produced by atomisation of molten lithium in an argon atmosphere at a temperature of 200-230° C. (U.S. Pat. No. 7,326,372, CHEMETALL GMBH, published Feb. 5, 2008). The disadvantage of said method is the need to use a complex device for atomisation of the lithium at a temperature of 200-230° C.

The use of finely dispersed lithium particles ensures the completeness of the alkyllithium formation reaction, however, it causes technological problems, in particular, particles that are too small easily form cakes on the filter equipment, which leads to frequent shutdowns.

Another important factor is that handling of finely dispersed lithium causes a high risk of fire.

U.S. Pat. No. 5,523,447 (FMC CORP, published Jun. 4, 1996) discloses a process for producing alkyllithium compounds by reacting lithium metal in the form of pieces having a weight of more than 0.5 grams with alkyl chloride at a molar ratio of lithium to alkyl chloride ranging from 3:1 to 20:1 in a hydrocarbon solvent in an inert atmosphere with moderate stirring or completely without stirring.

The disadvantage of said process is the high lithium to alkyl chloride ratio of 3:1 or higher. It is also possible that unreacted lithium may be entrained in the solution containing the target product and it exits the reactor and clogs pipes and fittings.

In addition, with slow or complete absence of stirring, lithium metal quickly fouls with the lithium chloride sludge, and subsequent washing with a fresh solvent, as proposed in the above patent, does not allow the sludge to be completely removed. Also, as the reaction proceeds, lithium chloride is formed on the surface of lithium metal, as a result, the access of butyl chloride to uncontaminated lithium metal is hindered, and the preferential side reaction of butyl chloride with the formed butyllithium begins to proceed to produce lithium chloride and octane.

Thus, there remains a need to provide a process for producing an alkyllithium solution which overcomes all the aforementioned disadvantages.

### SUMMARY OF THE INVENTION

The object of the present invention is to provide an effective process for producing an alkyllithium solution using lithium metal with a relatively low specific surface area while ensuring a high yield of alkyllithium, which overcomes all the aforementioned disadvantages associated with the use of finely dispersed lithium metal particles (lithium with a high specific surface area).

This object is achieved by providing a process for producing an alkyllithium solution by reacting lithium metal having a specific surface area of from 1 to 100 cm²/g with an alkyl halide in an organic solvent medium under conditions of high turbulence, wherein the molar ratio of lithium metal to alkyl halide is from 2.5:1 to 5.5:1.

The term “high turbulence” in the context of the present invention shall be understood to mean a flow regime of the reaction flow with a Reynolds number of more than 10,000, characterized by an extremely irregular, random change in speed over time at each point of the reaction flow.

The technical result achieved by the present invention consists in achieving an alkyllithium yield of more than 90% using lithium metal with a specific surface area of from 1 to 100 cm²/g and an alkyl halide in an organic solvent medium under conditions of high turbulence, at a molar ratio of lithium metal to alkyl halide of from 2.5:1 to 5.5:1, which is comparable to the alkyllithium yield achieved using finely dispersed particles of lithium metal having a high specific surface area.

An additional technical result achieved by the present invention consists in reducing the number of steps of the process for producing an alkyllithium solution, since there is need to pre-disperse lithium metal to obtain finely dispersed particles of lithium metal, as well as to perform their subsequent washing from the dispersion medium (oil or paraffin). This also allows to minimize the loss of lithium metal that may occur at each of these steps.

An additional technical result achieved by the present invention consists in increasing the fire and explosion safety of the process for producing an alkyllithium solution, since there is no need to use finely dispersed particles of lithium metal, which are highly pyrophoric.

In addition, It has unexpectedly been found by the present inventors that the use of lithium metal with a specific surface area of from 1 to 100 cm²/g under conditions of high turbulence, at the molar ratio of lithium metal to alkyl halide of from 2.5:1 to 5.5:1 allows the synthesis of alkyllithium to achieve an alkyllithium yield of more than 90% without a significant increase in reaction time compared to the use of finely dispersed particles of lithium metal.

### DETAILED DESCRIPTION OF THE INVENTION

The following is a detailed description of various aspects and embodiments of the present invention.

The present invention relates to a process for producing an alkyllithium solution by reacting lithium metal having a specific surface area of from 1 to 100 cm²/g, preferably from 5 to 70 cm²/g, most preferably from 10 to 30 cm²/g with an alkyl halide in an organic solvent medium under conditions of high turbulence, wherein the molar ratio of lithium metal to alkyl halide may be from 2.5:1 to 5.5:1, preferably from 2.5:1 to 5:1, more preferably from 3:1 to 4.5:1.

Lithium metal can be used in any form, for example, in the form of pieces, cylinders, having a weight of from 0.05 to 1 g, preferably from 0.08 to 0.8 g, most preferably from 0.1 to 0.5 g.

The specific surface area of the lithium metal used can be determined by any method known from the prior art, both calculation and experimental methods, for example, by low-temperature nitrogen adsorption in accordance with the Brunauer-Emmett-Teller method (BET). The calculation method is based on geometric concepts of the shape and size of lithium metal. For example, the specific surface area of lithium metal in the form of a cylinder can be determined using the following formula: the surface area of the cylinder 2πrh+2πr², where h is the height of the cylinder, r is the diameter of the cylinder, divided by the mass of the cylinder.

The sodium content of the lithium metal can vary from 50 to 2000 ppm, preferably from 100 to 1500 ppm, more preferably from 150 to 1000 ppm, more preferably from 250 to 500 ppm.

Chlorides, bromides or iodides may be used as alkyl halides, but most preferably chlorides are used. The alkyl chloride includes, but is not limited to: methyl chloride, ethyl chloride, n-propyl chloride, n-butyl chloride, sec-butyl chloride, tert-butyl chloride and n-hexyl chloride. Preferred are n-butyl chloride, sec-butyl chloride or tert-butyl chloride.

Suitable organic solvents include, but are not limited to: C5-C7 alkanes, for example, n-hexane, n-heptane; cycloalkanes, for example, cyclohexane; or mixtures thereof in various ratios, such as nefras and petroleum ether. Preferably, hexane, cyclohexane or nefras are used, most preferably hexane and nefras, for example, nefras P 1 63/75, which is a hexane-heptane fraction.

The dosing rate of the required amount of alkyl halide added to lithium metal in an organic solvent can be any dosing rate and it is selected so that the temperature of alkyllithium synthesis does not exceed 75° C., preferably ranges from 50 to 73° C., more preferably from 60 to 70° C. If the temperature exceeds 75° C., a preferential side reaction of lithium chloride formation of may occur.

The time of the alkyllithium synthesis can be any time sufficient to achieve zero alkyl halide content in the reaction mass. In a preferred embodiment, the time of alkyllithium synthesis can be up to 24 hours, preferably up to 18 hours, most preferably up to 10 hours.

After completion of dosing, the reaction mass is kept for 2 to 8 hours, preferably for 4 to 8 hours at a temperature of from 55 to 85° C., preferably from 65 to 75° C.

The type of stirring device and the stirring speed are not critical when implementing the process of the present invention, any stirring device and stirring speed can be used, provided that the turbulence energy dissipation rate (ε) ranging from 0.01 to 0.3 m²/s³ is ensured, preferably from 0.02 to 0.2 m²/s³, more preferably from 0.03 to 0.1 m²/s³. By maintaining the turbulence energy dissipation rate (ε) in a given range, it is possible to provide the required conditions of high turbulence of the reaction mass flow in the reactor, which makes it possible to prevent the adhesion of lithium chloride sludge to the surface of lithium metal and, as a consequence, to ensure effective interaction of lithium metal with alkyl halide. At an energy dissipation rate (ε) above 0.3 m²/s³, the yield of alkyllithium can decrease due to the fact that the mixture of solvent and alkyl halide is predominantly distributed near the reactor walls and weakly interacts with lithium metal; in addition, separate circulation circuits of the reaction mass may form, which also weakly interact with each other.

The stirring time corresponds to the total dosing time and the holding time of the reaction mass after completion of dosing of the alkyl halide.

The process for producing an alkyllithium solution must be carried out in a reactor made of a material inert to the substances used in the process for producing an alkyllithium solution. In particular, the process for producing an alkyllithium solution can be carried out in a titanium reactor, a stainless steel reactor or an enameled reactor.

Alkyllithium solution obtained as a result of the synthesis is subjected to filtration to purify it from lithium chloride sludge, where the content of lithium chloride sludge in the alkyllithium solution should not exceed 0.4%, preferably the sludge should be completely absent. Filtration can be carried out at any temperature, preferably at a temperature of from 20 to 40° C., more preferably from 20 to 30° C., using any filtration devices known from the prior art, for example, filters with porous filter walls and nutsche filters, it is preferable to use nutsche filters.

The filtered alkyllithium solution can be further diluted with an organic solvent to obtain the required concentration for subsequent use as an initiator in the polymerization of dienes and copolymerization of dienes, for example, with vinyl aromatic compounds, as well as to bring it into line with the Agreement Concerning the International Carriage of Dangerous Goods by Road (ARD). In particular, n-butyllithium, which is in the form of a solution with a concentration of n-butyllithium of from 15 to 90%, belongs to the class of substances capable of spontaneous combustion (Class 4.2), and therefore it is only transported in accordance with the ARD.

The alkyllithium produced in accordance with the process of the present invention may include, but is not limited to: propyllithium, butyllithium, amyllithium, hexyllithium, preferably butyllithium.

### IMPLEMENTATION OF THE INVENTION

### Example 1 (Comparative)

151.5 g of lithium and 2 kg of nefras (P 1 63/75) were added to a 5 L reactor. Lithium was used in the form of a dispersion having a specific surface area of 293 cm²/g. The reactor contents were heated to 60° C., then 1 kg of n-butyl chloride was dosed over 7 hours at 300 rpm so that the reaction temperature did not exceed 70° C. The molar ratio of lithium to n-butyl chloride was 2.02:1. Upon completion of dosing of n-butyl chloride, the reaction mass was kept for 8 hours at a temperature of 65° C. The yield of n-butyllithium was 99.2%.

### Example 2 (Comparative)

151.5 g of lithium and 2 kg of nefras (P 1 63/75) were added to a 5 L reactor. Lithium was used in the form of cylinders having dimensions of 6×12 mm and a specific surface area of 15.6 cm²/g, as determined by calculation method. The reactor contents were heated to 60° C., then 1 kg of n-butyl chloride was dosed over 7 hours with stirring at 300 rpm (corresponds to ε of 0.05 m²/s³) so that the reaction temperature did not exceed 70° C. The molar ratio of lithium to n-butyl chloride was 2.02:1. Upon completion of dosing of n-butyl chloride, the reaction mass was kept for 8 hours at a temperature of 65° C. The yield of n-butyllithium was 66.7%.

### Example 3 (According to the Present Invention)

The preparation of n-butyllithium was performed in analogy to Example 2, except that the molar ratio of lithium to n-butyl chloride was 3:1. The yield of n-butyllithium was 95.2%.

### Example 4 (According to the Present Invention)

The preparation of n-butyllithium was performed in analogy to Example 3, except that the stirring speed was 500 rpm (corresponds to ε of 0.15 m²/s³). The yield of n-butyllithium was 97.2%.

### Example 5 (According to the Present Invention)

The preparation of n-butyllithium was performed in analogy to Example 2, except that the molar ratio of lithium to n-butyl chloride was 4:1. The yield of n-butyllithium was 99.3%.

### Example 6 (According to the Present Invention)

The preparation of n-butyllithium was performed in analogy to Example 5, except that the stirring speed was 500 rpm (corresponds to ε of 0.15 m²/s³). The yield of n-butyllithium was 99.4%.

### Example 7 (According to the Present Invention)

The preparation of n-butyllithium was performed in analogy to Example 5, except that the stirring speed was 600 rpm (corresponds to ε of 0.28 m²/s³). The yield of n-butyllithium was 99.4%.

### Example 8 (According to the Present Invention)

The preparation of n-butyllithium was performed in analogy to Example 2, except that the molar ratio of lithium to n-butyl chloride was 4.5:1. The yield of n-butyllithium was 99.2%.

### Example 9 (According to the Present Invention)

225 g of lithium and 2 kg of nefras (P 1 63/75) were added to a 5 L reactor. Lithium was used in the form of tablets having dimensions of 10×5 mm and a specific surface area of 15 cm²/g, as determined by calculation method. The reactor contents were heated to 60° C., then 1 kg of n-butyl chloride was dosed over 7 hours with stirring at 300 rpm (corresponds to ε of 0.05 m²/s³) so that the reaction temperature did not exceed 70° C. The molar ratio of lithium to n-butyl chloride was 3:1. Upon completion of dosing of n-butyl chloride, the reaction mass was kept for 8 hours at a temperature of 65° C. The yield of n-butyllithium was 94.6%.

### Example 10 (According to the Present Invention)

The preparation of n-butyllithium was performed in analogy to Example 9, except that the molar ratio of lithium to n-butyl chloride was 4.5:1. The yield of n-butyllithium was 99.2%.

### Example 11 (Comparative)

300 g of lithium and 2 kg of nefras (P 1 63/75) were added to a 5 L reactor. Lithium was used in the form of pieces having a specific surface area of 6.3 cm²/g, as determined by calculation method. The reactor contents were heated to 60° C., then 1 kg of n-butyl chloride was dosed over 7 hours with stirring at 150 rpm (corresponds to ε of 0.006 m²/s³) so that the reaction temperature did not exceed 70° C. The molar ratio of lithium to n-butyl chloride was 4:1. Upon completion of dosing of n-butyl chloride, the reaction mass was kept for 8 hours at a temperature of 65° C. The yield of n-butyllithium was 67.8%.

### Example 12 (According to the Present Invention)

The preparation of n-butyllithium was performed in analogy to Example 11, except that the stirring speed was 300 rpm (corresponds to ε of 0.05 m²/s³). The yield of n-butyllithium was 90.3%.

### Example 13 (According to the Present Invention)

The preparation of n-butyllithium was performed in analogy to Example 11, except that the stirring speed was 500 rpm (corresponds to ε of 0.15 m²/s³). The yield of n-butyllithium was 92.4%.

### Example 14 (According to the Present Invention)

225 g of lithium and 2 kg of nefras (P 1 63/75) were added to a 5 L reactor. Lithium was used in the form of cylinders having dimensions of 6×6 mm and a specific surface area of 25.7 cm²/g, as determined by calculation method. The reactor contents were heated to 60° C., then 1 kg of n-butyl chloride was dosed over 7 hours with stirring at 150 rpm (corresponds to ε of 0.006 m²/s³) so that the reaction temperature did not exceed 70° C. The molar ratio of lithium to n-butyl chloride was 3:1. Upon completion of dosing of n-butyl chloride, the reaction mass was kept for 8 hours at a temperature of 65° C. The yield of n-butyllithium was 92.5%.

### Example 15 (According to the Present Invention)

The preparation of n-butyllithium was performed in analogy to Example 14, except that the stirring speed was 300 rpm (corresponds to ε of 0.05 m²/s³). The yield of n-butyllithium was 97.3%.

### Example 16 (According to the Present Invention)

The preparation of n-butyllithium was performed in analogy to Example 14, except that the stirring speed was 600 rpm (corresponds to ε of 0.28 m²/s³). The yield of n-butyllithium was 99.3%.

### Example 17 (Comparative)

225 g of lithium and 2 kg of nefras (P 1 63/75) were added to a 5 L reactor. Lithium was used in the form of pieces having a specific surface area of 0.42 cm²/g, as determined by calculation method. The reactor contents were heated to 60° C., then 1 kg of n-butyl chloride was dosed over 7 hours with stirring at 300 rpm (corresponds to ε of 0.05 m²/s³) so that the reaction temperature did not exceed 70° C. The molar ratio of lithium to n-butyl chloride was 3:1. Upon completion of dosing of n-butyl chloride, the reaction mass was kept for 8 hours at a temperature of 65° C. The yield of n-butyllithium was 61.3%.

### Example 18 (Comparative)

The preparation of n-butyllithium was performed in analogy to Example 17, except that the stirring speed was 800 rpm (corresponds to ε of 0.6 m²/s³). The yield of n-butyllithium was 63%.

### Example 19 (According to the Present Invention)

300 g of lithium and 2 kg of nefras (P 1 63/75) were added to a 5 L reactor. Lithium was used in the form of a ribbon (0.4×25×80 mm) having a specific surface area of 96.3 cm²/g, as determined by calculation method. The reactor contents were heated to 60° C., then 1 kg of n-butyl chloride was dosed over 7 hours with stirring at 300 rpm (corresponds to ε of 0.05 m²/s³) so that the reaction temperature did not exceed 70° C. The molar ratio of lithium to n-butyl chloride was 4:1. Upon completion of dosing of n-butyl chloride, the reaction mass was kept for 8 hours at a temperature of 65° C. The yield of n-butyllithium was 99.2%.

1. A process for producing alkyllithium by reacting lithium metal having a specific surface area of from 1 to 100 cm²/g with an alkyl halide in an organic solvent medium under conditions of high turbulence, wherein the molar ratio of lithium metal to alkyl halide is from 2.5:1 to 5.5:1.

2. The process of claim 1, wherein the lithium metal used has a specific surface area of from 5 to 70 cm²/g, preferably from 10 to 30 cm²/g.

3. The process of claim 1, wherein the alkyl halide used is an alkyl chloride, an alkyl bromide or an alkyl iodide.

4. The process of claim 3, wherein the alkyl chloride used is methyl chloride, ethyl chloride, n-propyl chloride, n-butyl chloride, sec-butyl chloride, tert-butyl chloride and n-hexyl chloride.

5. The process of claim 1, wherein the reaction of lithium metal with alkyl halide is carried out at a turbulence energy dissipation rate (ε) of from 0.01 to 0.3 m²/s³.

6. The process of claim 1, wherein the molar ratio of lithium metal to alkyl halide is from 2.5:1 to 5.5:1.

7. The process of claim 1, wherein the organic solvent used is a C5-C7 alkane.

8. The process of claim 7, wherein the organic solvent used is hexane, cyclohexane or nefras.

9. The process of claim 1, wherein the dosing of alkyl halide to the lithium metal in an organic solvent is carried out so that the temperature of the alkyllithium synthesis does not exceed 75° C.

10. The process of claim 1, wherein the lithium metal used has a specific surface area of from 10 to 30 cm²/g.

11. The process of claim 1, wherein the alkyl halide used is an alkyl chloride.

12. The process of claim 3, wherein the alkyl chloride used is n-butyl chloride, sec-butyl chloride or tert-butyl chloride.

13. The process of claim 1, wherein the reaction of lithium metal with alkyl halide is carried out at a turbulence energy dissipation rate (ε) of from 0.02 to 0.2 m²/s³.

14. The process of claim 1, wherein the reaction of lithium metal with alkyl halide is carried out at a turbulence energy dissipation rate (ε) of from 0.03 to 0.1 m²/s³.

15. The process of claim 1, wherein the molar ratio of lithium metal to alkyl halide is from 3:1 to 4.5:1.

16. The process of claim 1, wherein the organic solvent used is-n-hexane, n-heptane; a cycloalkane.

17. The process of claim 1, wherein the organic solvent used is-cyclohexane; or a mixture thereof in various ratios, including nefras (petroleum solvent) and petroleum ether.

18. The process of claim 7, wherein the organic solvent used is hexane, cyclohexane or nefras.

19. The process of claim 7, wherein the organic solvent used is hexane and nefras.

20. The process of claim 1, wherein the dosing of alkyl halide to the lithium metal in an organic solvent is carried out so that the temperature of the alkyllithium synthesis does not exceed 75° C.

21. The process of claim 1, wherein the dosing of alkyl halide to the lithium metal in an organic solvent is carried out so that the temperature of the alkyllithium synthesis ranges from 50 to 73° C.

22. The process of claim 1, wherein the dosing of alkyl halide to the lithium metal in an organic solvent is carried out so that the temperature of the alkyllithium synthesis ranges from 60 to 70° C.
